(19) United States
(12) Patent Application Publication
(10) Pub. No.: US 2014/0358648 A1
(43) Pub. Date: Dec. 4, 2014

(54) FARE COLLECTING APPARATUS AND METHOD USING AUTHORIZATION-ONLY TRANSACTIONS

(71) Applicant: SAMSUNG SDS CO., LTD., Seoul (KR)

(72) Inventors: Jae Hun JEONG, Seongnam-si (KR); Heung Woo LEE, Seongnam-si (KR); Jong Seop SONG, Seongnam-si (KR)

(73) Assignee: SAMSUNG SDS CO., LTD., Seoul (KR)

(21) Appl. No.: 14/291,917

(22) Filed: May 30, 2014

(30) Foreign Application Priority Data
May 31, 2013 (KR) 10-2013-0062188

(51) Int. Cl. G06Q 20/14; G06Q 20/34; G06Q 20/40

(52) U.S. Cl. CPC G06Q 20/145; G06Q 20/40; G06Q 20/34
USPC 705/13

(57) ABSTRACT

A fare collecting apparatus is provided. The fare collecting apparatus according to one implementation of this invention comprises, a declined card list storage unit configured to store a list of declined cards, including card information relating to each declined card, an authorization determination unit configured to search in the list of declined cards to determine whether card information included in the received card payment request is included in the list of declined cards, in response to receipt of a card payment request from a user, and an authorization-only transaction request unit configured to transmit an authorization-only transaction request message including a provisional authorization amount, to a payment gateway, if the card information included in the received card payment request is not included in the list of declined cards.

This application claims priority to Korean Patent Application No. 10-2013-0062188 filed on May 31, 2013 in the Korean Intellectual Property Office, the disclosure of which is incorporated herein by reference in its entirety.

### BACKGROUND

1. Field

The inventive concept relates to a fare collecting apparatus and method using authorization-only transactions.

2. Description of the Related Art

An authorization-only transaction is the practice of placing a “hold” on a certain amount against a user for a predetermined period of time in connection with a transaction done by the user and settling the transaction later. That is, in an authorization-only transaction, a payment request made within the amount that is being “held” against a user is simply reserved, and a transaction is settled later at the time of completion of the transaction.

### SUMMARY

Exemplary embodiments provide a fare collecting apparatus using authorization-only transactions, which is capable of quickly collecting payments and reducing the burden of card fees.

Exemplary embodiments also provide a fare collecting method using authorization-only transactions, which is capable of quickly collecting payments and reducing the burden of card fees.

However, exemplary embodiments are not restricted to those set forth herein. The above and other exemplary embodiments will become more apparent to one of ordinary skill in the art to which the invention pertains by referencing the detailed description given below.

According to an exemplary embodiment, a fare collecting apparatus, comprises, a declined card list storage unit configured to store a list of declined cards, including card information relating to each declined card, an authorization determination unit configured to search in the list of declined cards to determine whether card information included in the received card payment request is included in the list of declined cards, in response to receipt of a card payment request from a user, and an authorization-only transaction request unit configured to transmit an authorization-only transaction request message including a provisional authorization amount, to a payment gateway, if the card information included in the received card payment request is not included in the list of declined cards.

The fare collecting apparatus may further comprise a settlement request unit configured to aggregate an amount to be paid, included in the received card payment request, and send a settlement request for the aggregated mount to the payment gateway. The settlement request unit may be further configured to send the settlement request to the payment gateway if the aggregated amount exceeds the provisional authorization amount. The settlement request unit may be further configured to send the settlement request to the payment gateway if the aggregated amount exceeds a predetermined amount. The settlement request unit may be further configured to send the settlement request to the payment gateway repeatedly at a pre-determined interval of time.

The authorization determination unit may be further configured to output a rejection message, declining the received card payment request, in response to a determination being made that the card information included in the received card payment request is included in the list of declined cards.

The authorization determination unit may be further configured to output a rejection message, declining the received card payment request, in response to an amount to be paid, included in the received card payment request, exceeding the provisional authorization amount.

The provisional authorization amount may be set to pre-determined amount exceeding an amount to be paid included in the received card payment request.

The fare collecting apparatus may further comprise a declined card list update unit is further configured to delete card information from the list of declined cards, in response to an amount in arrears for a corresponding declined card being settled.

The fare collecting apparatus may further comprise a declined card list update unit configured add the card information included in the received card payment request to the list of declined cards, in response to receiving from the payment gateway, an approval-rejection message for the authorization-only transaction request message.

According to other exemplary embodiment, a fare collecting method, comprises, storing a list of declined cards, including card information relating to each declined card, in response to receipt of a card payment request from a user, searching in the list of declined cards to determine whether card information included in the received card payment request is included in the list of declined cards, and transmitting an authorization-only transaction request message, including a provisional authorization amount, to a payment gateway, if the card information included in the received card payment request is not included in the list of declined cards, and receiving an acknowledgement signal for the authorization-only transaction request message, and adding the card information included in the received card payment request to the list of declined cards, if the acknowledgement signal indicating that an authorization-only transaction request has been rejected.

According to still other exemplary embodiment, a computer program product comprising a non-transitory machine-readable medium storing instructions that, when executed by at least one programmable processor, cause the at least one programmable processor to perform operations comprises, storing a list of declined cards, including card information relating to each declined card, in response to receipt of a card payment request from a user, searching in the list of declined cards to determine whether card information included in the received card payment request is included in the list of declined cards, and transmitting an authorization-only transaction request message, including a provisional authorization amount, to a payment gateway, if the card information included in the received card payment request is not included in the list of declined cards, and receiving an acknowledgement signal for the authorization-only transaction request message, and adding the card information included in the received card payment request to the list of declined cards, if the acknowledgement signal indicating that an authorization-only transaction request has been rejected.

According to the exemplary embodiments, it is possible to realize a quick fare collecting by quickly authorizing a card payment request before the verification of a card. In addition, it is possible to reduce the card fees associated with card authentication according to an “open payment” method, by aggregating an amount to be paid and settling multiple transactions at the same time in the aggregated amount.

Other features and exemplary embodiments will be apparent from the following detailed description, the drawings, and the claims.

### BRIEF DESCRIPTION OF THE DRAWINGS

FIG. 1 is a schematic diagram illustrating a fare collecting apparatus according to an exemplary embodiment.

FIG. 2 is a block diagram illustrating the fare collecting apparatus of FIG. 1.

FIG. 3 is a diagram illustrating the operation of the fare collecting apparatus of FIG. 1, according to an exemplary embodiment.

FIG. 4 is a diagram illustrating the operation of the fare collecting apparatus of FIG. 1, according to another exemplary embodiment.

FIG. 5 is a diagram illustrating the operation of the fare collecting apparatus of FIG. 1, according to another exemplary embodiment.

FIG. 6 is a diagram illustrating the operation of the fare collecting apparatus of FIG. 1, according to another exemplary embodiment.

FIG. 7 is a flowchart illustrating a fare collecting method according to the exemplary embodiment of FIG. 3.

FIG. 8 is a flowchart illustrating a fare collecting method according to the exemplary embodiment of FIG. 4.

FIG. 9 is a flowchart illustrating a fare collecting method according to the exemplary embodiment of FIG. 5.

FIG. 10 is a flowchart illustrating a fare collecting method according to the exemplary embodiment of FIG. 6.

### DETAILED DESCRIPTION OF THE EMBODIMENTS

Advantages and features of the inventive concept and methods of accomplishing the same may be understood more readily by reference to the following detailed description of preferred embodiments and the accompanying drawings. The inventive concept may, however, be embodied in many different forms and should not be construed as being limited to the embodiments set forth herein. Rather, these embodiments are provided so that this disclosure will be thorough and complete and will fully convey the inventive concept to those skilled in the art, and the inventive concept will only be defined by the appended claims. Like reference numerals refer to like elements throughout the specification.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

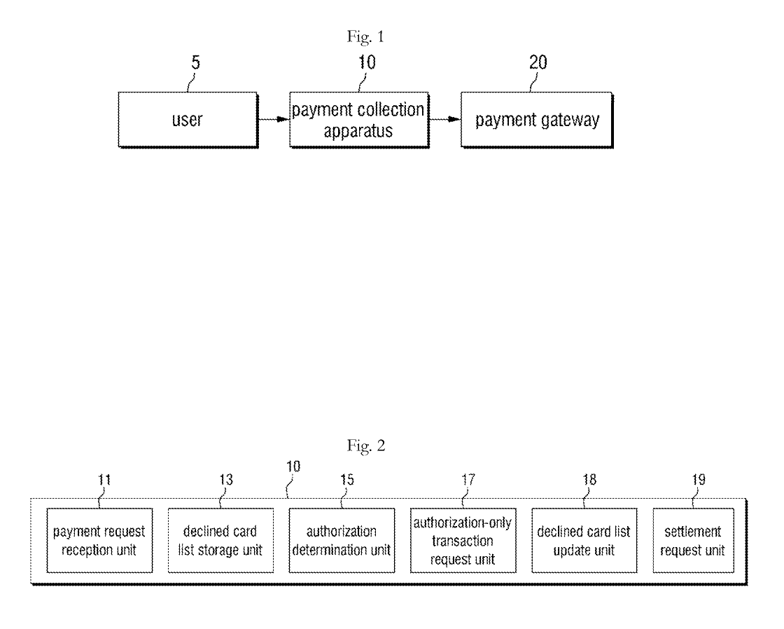

FIG. 1 is a schematic diagram illustrating a fare collecting apparatus according to an exemplary embodiment. Referring to FIG. 1, a fare collecting apparatus 10 may be connected between a user 5 and a payment gateway 20 and may thus transmit various information to or receive various information from the user 5 and the payment gateway 20. For example, a card payment request or a payment request authorization message may be transmitted between the user 5 and the fare collecting apparatus 10, and a card authentication request or a card payment request may be transmitted between the fare collecting apparatus 10 and the payment gateway 20.

In an exemplary embodiment, the fare collecting apparatus 10 may be connected to the user 5 and the payment gateway 200 via a network, and the network may be a wired or wireless network. In an exemplary embodiment, to receive a payment request from the user 5, the fare collecting apparatus 10 may include a tag module (not illustrated) that the user 5 can tag his or her card on.

FIG. 2 is a block diagram illustrating the fare collecting apparatus 10. Referring to FIG. 2, the fare collecting apparatus 10 may include a payment request reception unit 11, a declined card list storage unit 13, an authorization determination unit 15, an authorization-only transaction request unit 17, a declined card list update unit 18 and a settlement request unit 19.

The payment request reception unit 11 may receive a card payment request from the user 5. In an exemplary embodiment, the payment request reception unit 11 may include a tag module that the user 5 can tag his or her card on. For example, the user 5 may send a card payment request to the payment request reception unit 11 of the fare collecting apparatus 10 by tagging his or her card on the tag module of the payment request reception unit 11.

The declined card list storage unit 13 may store a list of declined cards, including card information relating to each card that has been declined in connection with a card payment request made therefor. In response to receipt of a card payment request from the user 5, the authorization determination unit 15 may search through the list of declined cards to determine whether card information included in the received card payment request is included in the received card payment request. In response to a determination being made that the card information included in the received card payment request is not included in the list of declined cards, the authorization determination unit 15 may output an authorization message authorizing the received card payment request. In response to a determination being made that the card information included in the received card payment request is included in the list of declined cards, the authorization determination unit 15 may output a rejection message declining the received card payment request.

In response to receipt of an authorization message from the authorization determination unit 15, the authorization-only transaction request unit 17 may transmit an authorization-only transaction request message, including a provisional authorization amount, to the payment gateway 20.

The term “provisional authorization amount”, as used herein, may indicate a range of amounts in which a card payment request can be made and authorized before the settlement of a transaction. In an exemplary embodiment, an “open payment” method using authorization-only transactions may be used. In the “open payment” method, a certain amount may be “held” against the user 5 for a certain period of time in connection with a transaction done by the user 5, and the transaction may be settled later. That is, in an authorization-only transaction, a payment request being made within the amount that is being “held” is simply reserved, and a transaction is settled later at the time of completion of the transaction. For this, a provisional authorization amount needs to be set to limit the amount that is to be “held” for a certain period of time. The payment gateway 20 may place a “hold” on as much an amount as the provisional authorization amount information. In an exemplary embodiment, the provisional authorization amount may be set in advance to an amount exceeding an amount to be paid, included in the received card payment request.

According to the exemplary embodiment of FIG. 2, a quick authorization process can be serviced to the user 5 by using authorization-only transactions. More specifically, in response to the user 5 making a card payment request to the fare collecting apparatus 10 within the provisional authorization amount, the fare collecting apparatus 10 may search through the list of declined cards to determine whether the user 5's card is included in the list of declined cards, and may authorize the card payment request without waiting for approval from the credit card company if the user 5's card is not a declined card.

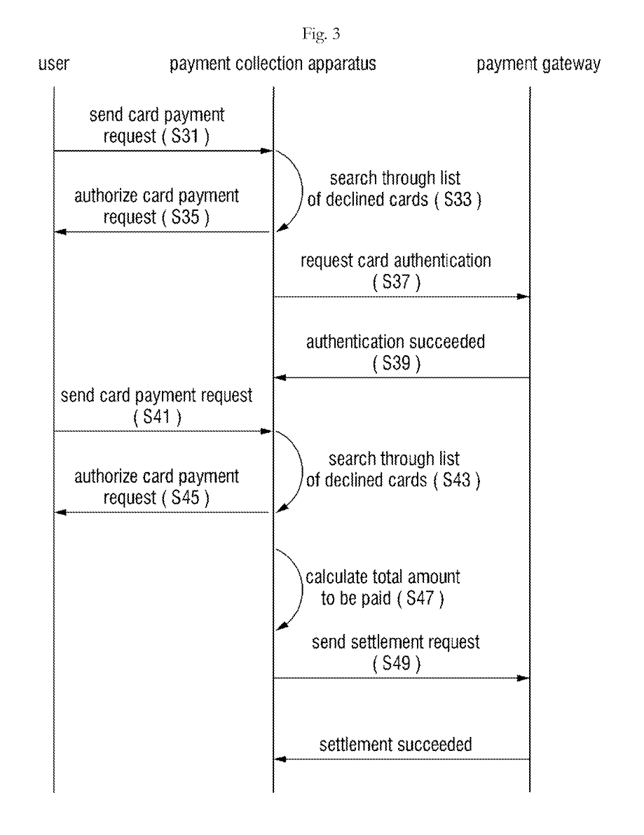

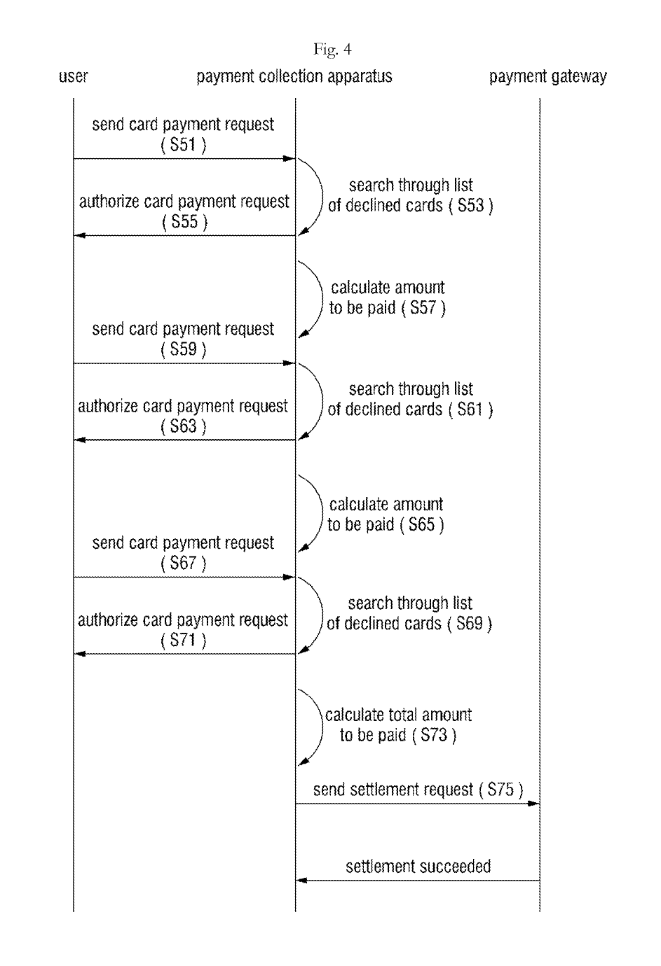

In response to receipt of the authorization-only transaction request message transmitted by the authorization-only transaction request unit 17, the payment gateway 20 performs a card authentication process. The card authentication process may be a process for verifying the validity of the user 5's card. For example, the card authentication process may involve determining the validity of the card number and expiration date of the user 5's card and determining whether the user 5's card has been maxed out and whether the user 5's card is on a “blacklist” Once the card authentication process is complete, an actual payment may be made later in connection with the received card payment request, and this will be described later in further detail with reference to FIGS. 3 and 4.

The declined card list update unit 18 may receive an acknowledgement signal for the authorization-only transaction request message transmitted by the authorization-only transaction request unit 17. In response to the acknowledgement signal including information indicating that the user 5's card is declined, the declined card list update unit 18 may add the card information included in the received card payment request to the list of declined cards. The declined card list update unit 18 may delete card information from the list of declined cards in response to an amount in arrears for the corresponding declined card being settled.

The settlement request unit 19 may aggregate an amount to be paid, included in the received card payment request, and may send a settlement request for the aggregated amount to the payment gateway 20. In an exemplary embodiment, in response to the aggregated amount exceeding the provisional authorization amount, the settlement request unit 19 may send a settlement request to the payment gateway 20. In another exemplary embodiment, in response to the aggregated amount exceeding a predetermined amount, the settlement request unit 19 may send a settlement request to the payment gateway 20. In another exemplary embodiment, the settlement request unit 19 may send a settlement request to the payment gateway 20 at regular intervals of time.

FIG. 3 is a diagram illustrating the operation of the fare collecting apparatus 10, according to an exemplary embodiment. Referring to FIG. 3, the payment request reception unit 11 may receive a card payment request from a user (S31). The authorization determination unit 15 may search through a list of declined cards present in the declined card list storage unit 13 to determine whether the user's card is included in the list of declined cards (S33). In the description that follows, it is assumed that the user's card information is not included in the list of declined cards. The authorization determination unit 15 may output an authorization message authorizing the received card payment request (S35). That is, the received card payment request may be quickly authorized even before the verification of the user's card, thereby improving user convenience.

In response to receipt of the authorization message from the authorization determination unit 15, the authorization-only transaction request unit 17 may transmit an authorization-only transaction request message to the payment gateway 20 so as to request the authentication of the user's card (S37). Accordingly, the payment gateway 20 may place a “hold” on as much an amount as the provisional authorization amount included in the received card payment request.

The payment gateway 20 may perform a card authentication process, which is a process for determining the validity of the user's card. For example, the payment gateway 20 may determine the validity of the card number and expiration date of the user's card, and may also determine whether the user's card has been maxed out and whether the user's card is on a “blacklist” In response to the user's card being successfully authenticated, the payment gateway 20 may transmit an “Authenticated Succeeded” message to the fare collecting apparatus 10. In response to the user's card failing the card authentication process, the payment gateway 20 may transmit an “Authentication Failed” message to the fare collecting apparatus 10. In the description that follows, it is assumed that the user's card is successfully authenticated. The payment gateway 20 may transmit an “Authenticated Succeeded” message to the fare collecting apparatus 10 (S39).

In response to receipt of an additional card payment request from the user, the additional card payment request may be handled (S41, S43 and S45) in the same manner as the card payment request received in step S31.

The settlement request unit 19 may aggregate a total amount of money to be paid, included in each card payment received from the user (S47). The settlement request unit 19 may send a settlement request for the aggregated total amount to the payment gateway 20 (S49). More specifically, in an exemplary embodiment, in response to the aggregated total amount exceeding a provisional authorization amount, the settlement request unit 19 may send a settlement request for the aggregated total amount to the payment gateway 20. In another exemplary embodiment, in response to the aggregated total amount exceeding a predetermined amount, the settlement request unit 19 may send a settlement request for the aggregated total amount to the payment gateway 20. In another exemplary embodiment, the settlement request unit 19 may send a settlement request to the payment gateway 20 at regular intervals of time. In response to a payment being made in the aggregated total amount, the payment gateway 20 may transmit a “Settlement Succeeded” message to the fare collecting apparatus 10.

According to the exemplary embodiment of FIG. 3, since a settlement request for the aggregated total amount is sent to the payment gateway 20 in response to the aggregated total amount exceeding the provisional authorization amount, it is possible to settle multiple transactions at the same time and thus to reduce the card fees associated with card authentication according to the “open payment” method. The operation of the fare collecting apparatus 10, according to another exemplary embodiment, will hereinafter be described with reference to FIG. 4.

FIG. 4 is a diagram illustrating the operation of the fare collecting apparatus 10, according to another exemplary embodiment. Referring to FIG. 4, the payment request reception unit 11 may receive a card payment request from a user (S51). The authorization determination unit 15 may search through a list of declined cards present in the declined card list storage unit 13 to determine whether the user's card is included in the list of declined cards (S53). In the description that follows, it is assumed that the user's card information is not included in the list of declined cards. The authorization determination unit 15 may output an authorization message authorizing the received card payment request (S55). That is, the received card payment request may be quickly authorized even before the verification of the user's card, thereby improving user convenience. The settlement request unit 19 may aggregate an amount to be paid, included in the received card payment request (S57).

The same steps as S51, S53, S55 and S57 may be performed twice (S59, S61, S63, S65, S67, S69, S71 and S73). Then, a settlement request for a aggregated total amount to be paid, obtained in step S73, may be made (S75). For example, in response to the aggregated total amount exceeding a provisional authorization amount, a settlement request for the aggregated total amount may be sent to the payment gateway 20. According to the exemplary embodiment of FIG. 4, since a settlement request for the aggregated total amount is sent to the payment gateway 20 in response to the aggregated total amount exceeding the provisional authorization amount, it is possible to settle multiple transactions at the same time and thus to reduce the card fees associated with card authentication according to the “open payment” method.

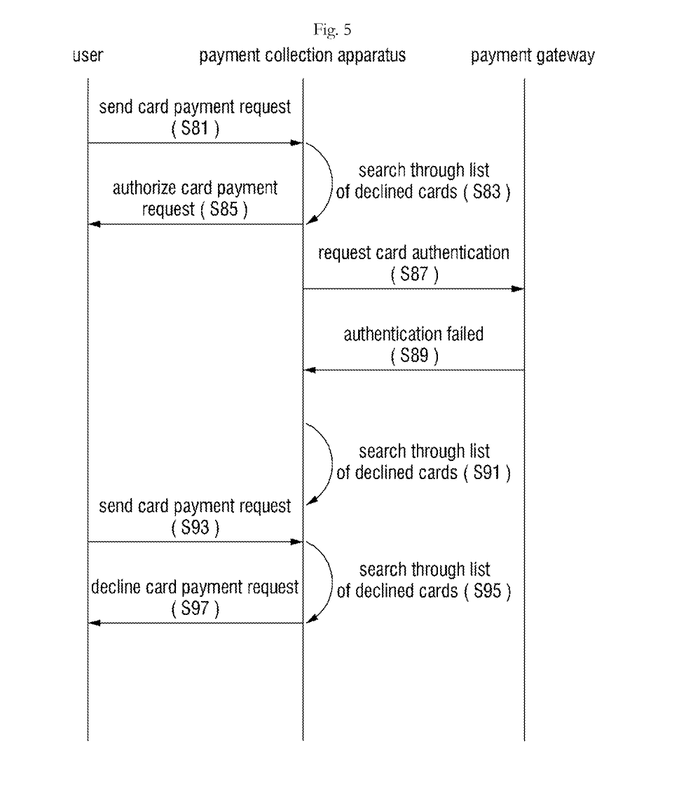

FIG. 5 is a diagram illustrating the operation of the fare collecting apparatus 10, according to another exemplary embodiment. Referring to FIG. 5, the payment request reception unit 11 may receive a card payment request from a user (S81). The authorization determination unit 15 may search through a list of declined cards present in the declined card list storage unit 13 to determine whether the user's card is included in the list of declined cards (S83). In the description that follows, it is assumed that the user's card information is not included in the list of declined cards. The authorization determination unit 15 may output an authorization message authorizing the received card payment request (S85). That is, the received card payment request may be quickly authorized even before the verification of the user's card, thereby improving user convenience.

In response to receipt of the authorization message from the authorization determination unit 15, the authorization-only transaction request unit 17 may transmit an authorization-only transaction request message, including a provisional authorization amount, to the payment gateway 20 so as to request the authentication of the user's card (S87). Accordingly, the payment gateway 20 may place a “hold” on as much an amount as the provisional authorization amount included in the received card payment request.

The payment gateway 20 may perform a card authentication process, which is a process for determining the validity of the user's card. For example, the payment gateway 20 may determine the validity of the card number and expiration date of the user's card, and may also determine whether the user's card has been maxed out and whether the user's card is on a “blacklist”. In response to the user's card being successfully authenticated, the payment gateway 20 may transmit an “Authenticated Succeeded” message to the fare collecting apparatus 10. In response to the user's card failing the card authentication process, the payment gateway 20 may transmit an “Authentication Failed” message to the fare collecting apparatus 10. In the description that follows, it is assumed that the user's card fails the card authentication process. The payment gateway 20 may transmit an “Authenticated Failed” message to the fare collecting apparatus 10 (S89). The declined card list update unit 18 may add the user's card information to the list of declined cards (S91).

The payment request reception unit 11 may receive another card payment request from the user's card, which has been added to the list of declined cards (S93). The authorization determination unit 15 may search through the list of declined cards to determine whether the user's card is included in the list of declined cards (S95). Since the user's card information has been added to the list of declined cards, the authorization determination unit 15 may output a rejection message (S97), declining the card payment request received in step S93.

Even when the user's card is not included in the list of declined cards, the authorization determination unit 15 may output a rejection message if an amount to be paid, included in a card payment request received from a user, exceeds the provisional authorization amount.

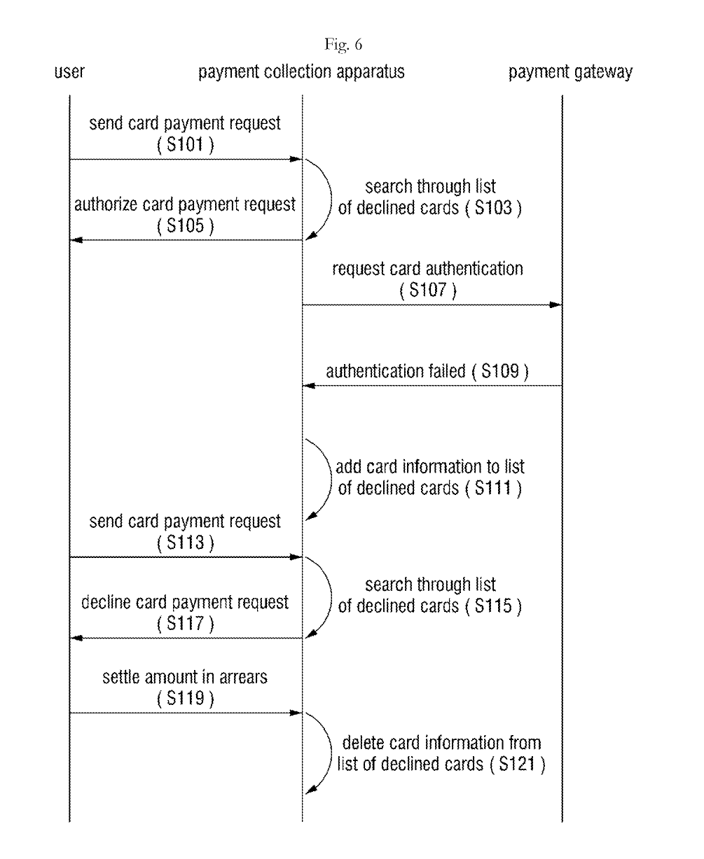

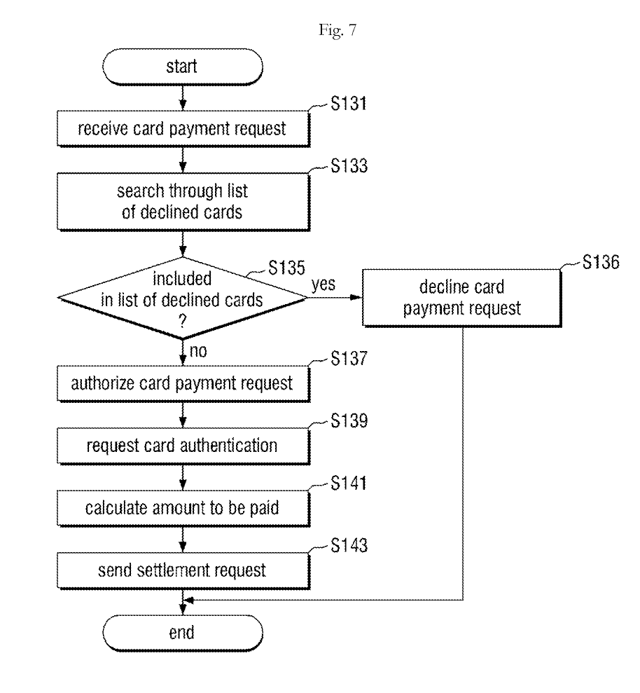

FIG. 6 is a diagram illustrating the operation of the fare collecting apparatus 10, according to another exemplary embodiment. Steps S101, S103, S105, S107, S109, S111, S113, S115, and S117 of FIG. 6 may be the same as steps S81, S83, S85, S87, S89, S91, S93, S95 and S97, respectively, of FIG. 5. Referring to FIG. 6, a card included in a list of declined cards may be deleted if an amount in arrears with a corresponding card payment is settled through, for example, a relevant website or customer service center. That is, in response to receipt of a message from a user, indicating that an amount in arrears for his or her card has been settled (S119), the declined card list update unit 18 may delete the user's card information from a list of declined cards (S121).

FIG. 7 is a flowchart illustrating a fare collecting method according to the exemplary embodiment of FIG. 3. Referring to FIG. 7, the fare collecting method may include: receiving a card payment request from a user; searching through a list of declined cards present in the declined card list storage unit 13 to determine whether the user's card is included in the list of declined cards (S131); determining whether the user's card is included in the list of declined card list (S135); in response to a determination being made that the user's card is included in the list of declined cards, declining the received card payment request (S136); in response to a determination being made that the user's card is not included in the list of declined cards, authorizing the received card payment request (S137); transmitting an authorization-only transaction request message to the payment gateway 20 so as to request the authentication of the user's card (S139); aggregating an amount to be paid, included in the received card payment request (S141); and sending a settlement request for the aggregated amount to the payment gateway 20. According to the fare collecting method of FIG. 7, it is possible to quickly authorize the user's card even before the verification of the user's card and thus to improve user convenience.

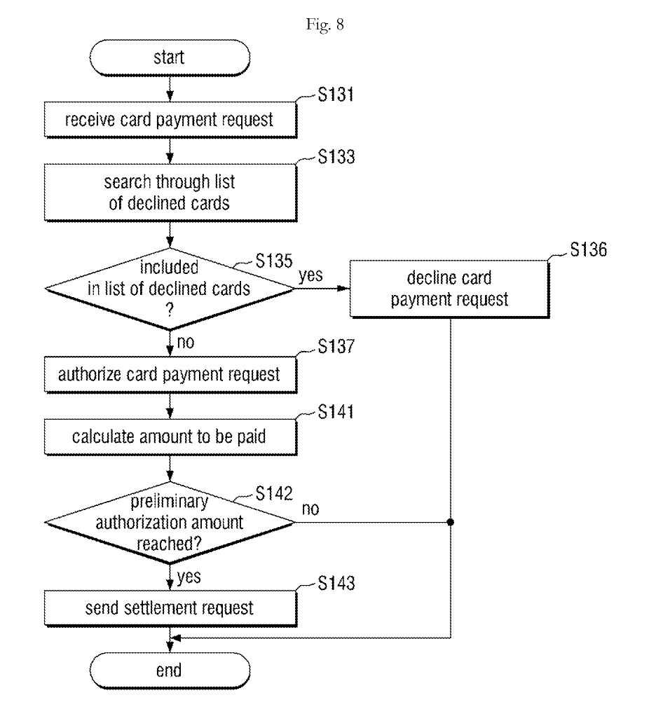

FIG. 8 is a flowchart illustrating a fare collecting method according to the exemplary embodiment of FIG. 4. Steps S131, S133, S135, S136 and S137 of FIG. 8 may be the same as their respective counterparts of FIG. 7. Referring to FIG. 8, in response to a received card payment request being authorized (S137), an amount to be paid, included in the received card payment request, may be aggregated (S141), and a determination may be made as to whether the aggregated amount reaches a provisional authorization amount (S142). In response to a determination being made that the aggregated amount is yet to reach the provisional authorization amount, the fare collecting apparatus 10 may defer the settlement of a payment until the aggregated amount reaches the provisional authorization amount. In response to a determination being made that the aggregated amount has reached the provisional authorization amount, the fare collecting apparatus 10 may send a settlement request to the payment gateway 20 (S143). According to the fare collecting method of FIG. 8, since an amount to be paid is aggregated and multiple transactions are settled at the same time in the aggregated amount, it is possible to reduce the card fees associated with card authentication according to the “open payment” method.

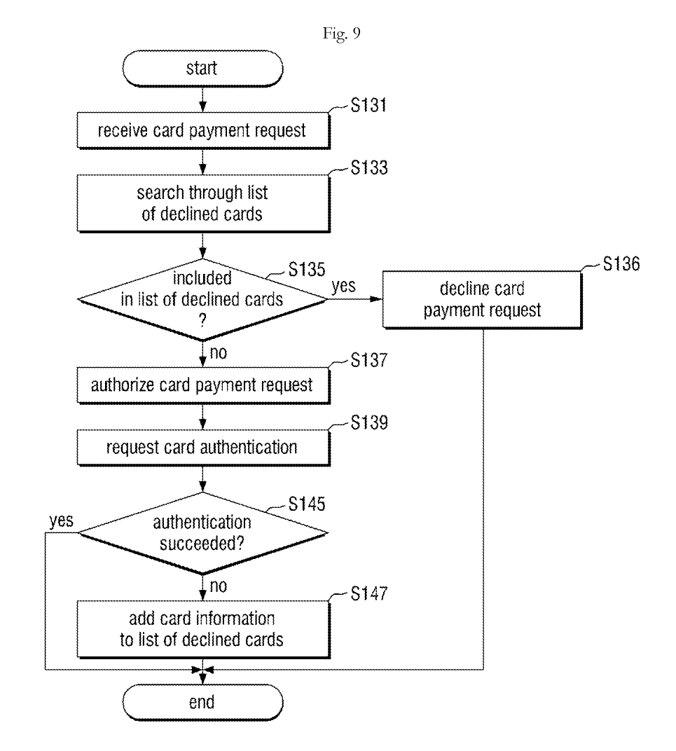

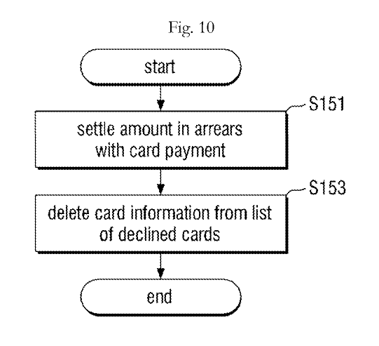

FIG. 9 is a flowchart illustrating a fare collecting method according to the exemplary embodiment of FIG. 5. Steps S131, S133, S135, S136, S137 and S139 of FIG. 9 may be the same as their respective counterparts of FIG. 7. Referring to FIG. 9, after the requesting of the authentication of a user's card by transmitting an authorization-only transaction request message to the payment gateway 20 (S139), a determination may be made as to whether the user's card has been successfully authenticated (S145). In response to a determination being made that the user's card has failed to be authenticated, the user's card information may be added to a list of declined cards (S147).

FIG. 10 is a flowchart illustrating a fare collecting method according to the exemplary embodiment of FIG. 6. Referring to FIG. 10, a card that has been added to a list of declined cards through the steps of the fare collecting method of FIG. 9 may be deleted from the list of declined cards (S153) in response to an amount in arrears with a corresponding card payment being settled through, for example, a relevant website or customer service center (S151).

As described above, according to the exemplary embodiments, it is possible to realize a quick fare collecting by quickly authorizing a card payment request before the verification of a card. In addition, it is possible to reduce the card fees associated with card authentication according to the “open payment” method, by aggregating an amount to be paid and settling multiple transactions at the same time in the aggregated amount.

This inventive concept, may be implemented, e.g., by using a computer readable code stored on a non-transitory computer-readable medium. For example, a computer program product comprising a non-transitory computer-readable medium storing instructions that, when executed by at least one hardware processor (e.g., a CPU or ASIC), cause the at least one hardware processor, in connection with a memory or storage under control of the processor, to perform the operations mentioned above. More particularly, each component mentioned as a “unit”, above, may be implemented as software that is run on the processor, as a hardware circuit, or as a combination of the two.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. Therefore, it is to be understood that the foregoing is illustrative of the inventive concept and is not to be construed as limited to the specific embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A fare collecting apparatus, comprising:
a declined card list storage unit configured to store, in a storage, a list of declined cards, including respective card information relating to each declined card of the list of declined cards;
an authorization determination unit configured to:
receive respective card information, relating to a received card payment request, as received card information, and
search, in the list of declined cards, to determine whether the received card information is included in the list of declined cards; and
an authorization-only transaction request unit configured to generate an authorization-only transaction request message including a provisional authorization amount, for transmission to a payment gateway, when the received card information is not included in the list of declined cards;
wherein one or more of the declined card list storage unit, the authorization determination unit, and the authorization-only transaction request unit is implemented by a hardware processor.

2. The fare collecting apparatus of claim 1, further comprising a settlement request unit configured to
aggregate an amount to be paid, included in the received card payment request, and
generate a settlement request, for the aggregated mount, for transmission to the payment gateway.

3. The fare collecting apparatus of claim 2, wherein the settlement request unit is further configured to output the settlement request for transmission to the payment gateway if when the aggregated amount exceeds the provisional authorization amount.

4. The fare collecting apparatus of claim 2, wherein the settlement request unit is further configured to output the settlement request for transmission to the payment gateway when the aggregated amount exceeds a predetermined amount.

5. The fare collecting apparatus of claim 2, wherein the settlement request unit is further configured to repeatedly output the settlement request for transmission to the payment gateway at pre-determined time intervals.

6. The fare collecting apparatus of claim 1, wherein the authorization determination unit is further configured to output a rejection message, declining the received card payment request, when the received card information is included in the list of declined cards.

7. The fare collecting apparatus of claim 1, wherein the authorization determination unit is further configured to output a rejection message, declining the received card payment request, when an amount to be paid, included in the received card payment request, exceeds the provisional authorization amount.

8. The fare collecting apparatus of claim 1, wherein the authorization-only request unit is further configured to calculate the provisional authorization amount by adding a pre-determined amount to an amount to be paid, included in the received card payment request.

9. The fare collecting apparatus of claim 1, further comprising a declined card list update unit configured to delete from the list of declined cards the respective card information of a settled card, included in the list of declined cards, in response to an indication that an amount in arrears for the settled card is settled.

10. The fare collecting apparatus of claim 1, further comprising a declined card list update unit configured to add the received card information to the list of declined cards when the authorization-only transaction request message is indicated as rejected.

11. A fare collecting method, comprising:
storing a list of declined cards in a storage, including respective card information relating to each declined card of the list of declined cards;
using respective card information, relating to a received card payment request, as received card information;
searching, in the list of declined cards, to determine whether the received card information is included in the list of declined cards;
generating an authorization-only transaction request message, including a provisional authorization amount, for transmission to a payment gateway, when the received card information is not included in the list of declined cards;
receiving an acknowledgement signal for the authorization-only transaction request message; and
adding the received card information to the list of declined cards when the acknowledgement signal indicates a rejection of the authorization-only transaction request;
wherein one or more of the storing, the using, the searching, the generating, the receiving, and the adding is performed with a hardware processor.

12. The fare collecting method of claim 11, further comprising:
aggregating an amount to be paid, included in the received card payment request, and
generating a settlement request, for the aggregated amount, for transmission to the payment gateway.

13. The fare collecting method of claim 11, further comprising outputting a rejection message declining the received card payment request, when the received card information is included in the list of declined cards.

14. The fare collecting method of claim 11, further comprising outputting a rejection message, declining the received card payment request, when an amount to be paid, included in the received card payment request, exceeds the provisional authorization amount.

15. The fare collecting method of claim 11, further comprising deleting from the list of declined cards the respective card information of a settled card, included in the list of declined cards, in response to an indication that an amount in arrears for the settled card is settled.

16. A computer program product comprising a non-transitory computer-readable medium storing instructions that, when executed by at least one hardware processor, cause the at least one hardware processor to perform operations comprising:
storing a list of declined cards in a storage, including respective card information relating to each declined card of the list of declined cards;
using respective card information, relating to a received card payment request, as received card information;
searching, in the list of declined cards, to determine whether the received card information is included in the list of declined cards;
generating an authorization-only transaction request message, including a provisional authorization amount, for transmission to a payment gateway, when the received card information is not included in the list of declined cards;
receiving an acknowledgement signal for the authorization-only transaction request message; and
adding the received card information to the list of declined cards when the acknowledgement signal indicates a rejection of the authorization-only transaction request.
